(19) United States
(12) Patent Application Publication
(10) Pub. No.: US 2013/0293216 A1
(43) Pub. Date: Nov. 7, 2013

(54) LAMINATED INDUCTOR ELEMENT

(71) Applicant: Murata Manufacturing Co., Ltd., Nagaokakyo-shi (JP)

(72) Inventors: Tomoya YOKOYAMA, Nagaokakyo-shi (JP); Takako SATO, Nagaokakyo-shi (JP)

(21) Appl. No.: 13/947,225

(22) Filed: Jul. 22, 2013

Related U.S. Application Data
(63) Continuation of application No. PCT/JP2011/076478, filed on Nov. 17, 2011.

(30) Foreign Application Priority Data
Feb. 15, 2011 (JP) 2011-029773

(51) Int. Cl. H01F 17/00

(52) U.S. Cl. CPC H01F 17/0013
USPC 323/355; 336/200

(57) ABSTRACT

A laminated inductor element includes a laminated substrate including a plurality of layers including a magnetic layer, an inductor including coil conductors provided between layers of the laminated substrate and connected in a lamination direction of the laminated substrate, and a pair of non-magnetic layers laminated on the laminated substrate so as to sandwich the laminated substrate in the lamination direction. The non-magnetic layers include cover layers made of low temperature co-fired ceramics.

### BACKGROUND OF THE INVENTION

1. Field of the Invention

The present invention relates to a laminated inductor element in which a laminated substrate including a magnetic layer is provided with coil conductors so as to define an inductor.

2. Description of the Related Art

In recent years, electronic components have been reduced in size and thickness. For example, there is a laminated ceramic electronic component in which a ceramic substrate including laminated insulating layers made of glass ceramics has coil conductors formed therein (see PCT Publication No. 2007/145189, for example). FIG. 1 is a cross-sectional view of a laminated ceramic electronic component described in PCT Publication No. 2007/145189.

The laminated ceramic electronic component described in PCT Publication No. 2007/145189 includes a ceramic laminate 101. The ceramic laminate 101 includes a ceramic base layer 102 formed with conductor patterns for forming a coil inside or outside thereof, and ceramic auxiliary layers 103 and 104 respectively laminated on upper and lower main surfaces of the ceramic base layer 102. The ceramic laminate 101 has the conductor patterns formed inside or outside thereof. The ceramic laminate 101 has a surface mounted with ICs (Integrated Circuits) such as surface mount components 109 and 110, and has conductor patterns 106 and 107 formed therein.

It is desirable that the ceramic base layer 102 is magnetic ferrite to obtain a high inductance value, and that the ceramic auxiliary layers 103 and 104 are low magnetic permeability or non-magnetic ferrite (Fe, Zn, or Cu, for example) to prevent a structural defect from occurring in a firing process due to, for example, a difference in shrinkage from the ceramic base layer 102 made of magnetic ferrite. With current flowing through the conductor patterns 106 and 107, an unnecessary magnetic field may be generated and affect, for example, electrical characteristics of the surface mount components 109 and 110 and coil patterns 108 formed inside the ceramic base layer 102. With the ceramic auxiliary layers 103 and 104 made of low magnetic permeability or non-magnetic ferrite, however, it is possible to suppress generation of the unnecessary magnetic field from the conductor patterns 106 and 107.

It is commonly known that a ferrite material has low resistance to organic acid. In PCT Publication No. 2007/145189, the surface mount components 109 and 110 and so forth are mounted on the ceramic auxiliary layer 103 by soldering. If the ceramic auxiliary layer 103 is made of non-magnetic ferrite, therefore, flux contained in solder, a plating process, and so forth are assumed to adversely affect the ferrite material. Further, what kind of process is to be performed on the electronic component in the assembling process or the like of an electronic device is unknown. It is therefore desirable that the electronic component is subjected to some kind of coating process.

### SUMMARY OF THE INVENTION

Accordingly, preferred embodiments of the present invention provide a laminated inductor element that prevents reduction in reliability when a component is mounted on a surface thereof.

A laminated inductor element according to a preferred embodiment of the present invention includes a laminated substrate including a plurality of layers including a magnetic layer, an inductor including coil conductors provided between layers of the laminated substrate and connected in a lamination direction of the laminated substrate, and a pair of non-magnetic layers laminated on the laminated substrate so as to sandwich the laminated substrate in the lamination direction. The non-magnetic layers include low temperature co-fired ceramics.

According to this configuration, the non-magnetic layers defining outermost layers include low temperature co-fired ceramics. It is therefore possible to ensure environmental resistance to processing such as soldering and plating when an electronic component is mounted on the non-magnetic layer, and to prevent a loss of reliability when the component is mounted on a surface thereof. Further, with the non-magnetic layers including low temperature co-fired ceramics, it is possible to co-fire the non-magnetic layers in a process of firing the laminated magnetic layers, and thus to increase the productivity of the laminated inductor element.

The low temperature co-fired ceramics may be provided (applied) only to a necessary portion of a surface of each of the non-magnetic layers, or may be provided to the entirety of the surfaces of the non-magnetic layers. Further, a main component of the non-magnetic layers may be the low temperature co-fired ceramics.

In the laminated inductor element according to a preferred embodiment of the present invention, it is preferable that each of the non-magnetic layers includes a conductor pattern provided on a surface thereof and a via conductor configured to electrically connect the conductor pattern and the coil conductor.

According to this configuration, it is possible to cause the conductor pattern on the surface and the coil conductor of the magnetic layer to be electrically conductive to each other, and thus to simplify a wiring structure.

In the laminated inductor element according to a preferred embodiment of the present invention, the laminated substrate may be configured to have an air gap formed about the coil conductor.

According to this configuration, the air gap is provided between the coil conductors. Accordingly, it is possible to increase the inductance value of laminated inductor element in a light load region, and further to maintain direct current superimposition characteristics in a heavy load region.

It is preferable to configure the laminated inductor element according to a preferred embodiment of the present invention such that the difference between a thermal expansion coefficient of the magnetic layer and a thermal expansion coefficient of the non-magnetic layer is greater than 0 ppm/° C. and less than 1 ppm/° C., for example

According to this configuration, the difference in thermal expansion coefficient between the magnetic layer and the non-magnetic layers is significantly reduced. Accordingly, it is possible to prevent, in the firing process, a crack from occurring from the air gap provided to increase the inductance value.

According to various preferred embodiments of the present invention, it is possible to prevent a loss of reliability when a component is mounted on a surface of a laminated inductor element, and to increase the productivity of the laminated inductor element.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view of a laminated ceramic electronic component described in PCT Publication No. 2007/145189.

FIG. 2 is a schematic cross-sectional view of a laminated inductor element.

FIG. 3 is a lamination diagram illustrating pre-firing layers of the laminated inductor element illustrated in FIG. 2.

FIG. 4 is a schematic cross-sectional view of another example of the laminated inductor element.

### DETAILED DESCRIPTION OF THE PREFERRED EMBODIMENTS

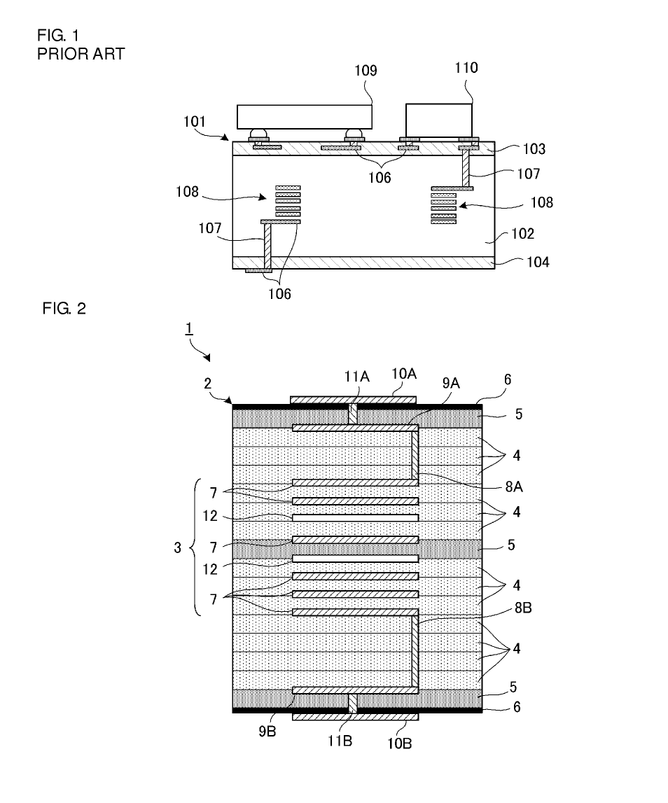

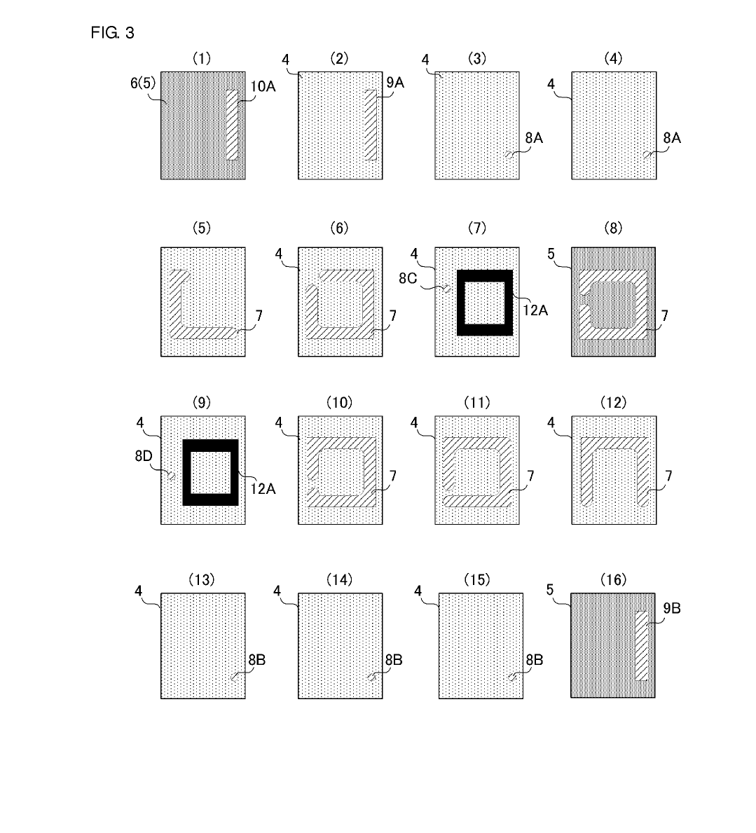

FIG. 2 is a schematic cross-sectional view of a laminated inductor element. FIG. 3 is a lamination diagram illustrating pre-firing layers of the laminated inductor element illustrated in FIG. 2. A laminated inductor element according to the present preferred embodiment is used in, for example, a non-insulating DC-DC converter mounted in a cellular phone or the like.

A laminated inductor element 1 includes a laminated substrate 2 and an inductor 3. The laminated substrate 2 is preferably includes sixteen layers in total including magnetic layers 4 and non-magnetic layers 5, for example. The first, eighth, and sixteenth layers from the upper surface of the laminated substrate 2 are the non-magnetic layers 5, and the other layers are the magnetic layers 4. Numbers in parentheses illustrated in FIG. 3 indicate the respective numbers of the layers. For example, the number of the first layer is represented as (1).

The magnetic layers 4 are preferably made of magnetic ferrite and a ceramic material. It is preferable that the magnetic layers 4 each have a post-firing thickness of approximately 100 μm to 2000 μm and a magnetic permeability of approximately 290, for example.

The non-magnetic layers 5 are mainly made of non-magnetic ferrite and a ceramic material. It is preferable that the non-magnetic layers 5 each have a post-firing thickness of approximately 10 μm to 100 μm and a magnetic permeability of approximately 1, for example. The non-magnetic layers 5 defining the outermost layers (the first and sixteenth layers) include cover layers 6 made of LTCC (low temperature co-fired ceramics) and each having a post-firing thickness of approximately 10 μm to 400 μm, for example.

It is possible to fire the LTCC forming the cover layers 6 at a “low temperature” of approximately 900° C. or lower, for example. Accordingly, it is possible to fire the cover layers 6 simultaneously with the laminated inductor element 1 including therein later-described coil conductors and so forth using Cu or Ag having a low melting point, and thus to integrate the cover layers 6 with the laminated inductor element 1.

These cover layers 6 are provided with mounting lands 10A and 10B serving as mounting terminals for electronic components to be mounted. With the LTCC cover layers 6 provided on respective surfaces of the non-magnetic layers 5, the erosion of the non-magnetic layers 5 by solder is prevented by the cover layers 6 in a case in which electronic components are mounted on the mounting lands 10A and 10B by soldering. Accordingly, it is possible to prevent a reduction in reliability of the laminated inductor element 1.

The inductor 3 is configured such that a plurality of coil conductors 7 are spirally connected via via-hole conductors (not illustrated), with the axial direction thereof corresponding to a substrate lamination direction of the laminated substrate 2. The coil conductors 7 are provided on the respective upper surfaces of the fifth to twelfth layers of the laminated substrate 2 excluding the seventh and ninth layers.

One end portion of the inductor 3, specifically, one end portion of the coil conductor 7 provided on the upper surface of the fifth layer is connected to a conductor 9A provided on the upper surface of the second layer of the laminated substrate 2 via a via-hole conductor 8A. The upper surface of the first layer is provided with the mounting land 10A, and the conductor 9A and the mounting land 10A are electrically conductive to each other via a via-hole conductor 11A provided in the first layer.

Further, the other end portion of the inductor 3, specifically, one end portion of the coil conductor 7 provided on the upper surface of the twelfth layer is connected to a conductor 9B provided on the upper surface of the sixteenth layer of the laminated substrate 2 via a via-hole conductor 8B. The lower surface of the sixteenth layer is provided with the mounting land 10B, and the conductor 9B and the mounting land 10B are electrically conductive to each other via a via-hole conductor 11B provided in the sixteenth layer.

The magnetic layers 4 defining the seventh and ninth layers not formed with the coil conductors 7 are provided with via-hole conductors 8C and 8D for making the upper and lower coil conductors 7 electrically conductive to each other.

That is, a configuration is provided in which a coil is connected between the mounting lands 10A and 10B, with one of the mounting lands 10A and 10B serving as an input terminal and the other one of the mounting lands 10A and 10B serving as an output terminal.

In a region of the laminated substrate 2 corresponding to the fifth to twelfth layers provided with the inductor 3, air gaps 12 are provided on the upper surface of the seventh layer and the upper surface of the ninth layer. In a manufacturing process, a burn-out paste 12A, such as carbon or resin, is applied to the upper surface of the seventh layer and the upper surface of the ninth layer, as illustrated in FIG. 3. The burn-out paste 12A is burned out during the firing of the laminated substrate 2 so as to form the air gaps 12. The burn-out paste 12A is applied in a ring shape. As a result, the air gaps 12 are provided in the spiral inductor.

If the air gaps 12 are not provided, compressive stress acts in the post-firing laminated substrate 2 due to the difference between the thermal expansion coefficient of the magnetic layers 4 and the thermal expansion coefficient of the non-magnetic layers 5, and thus results in a reduction in efficiency of the coil due to iron loss. With the provision of the air gaps 12, therefore, it is possible to mitigate the stress around the coil conductors 7, and thus to achieve the improvement of coil characteristics, such as the improvement of the inductance value or the improvement of the voltage conversion ratio due to the suppression of the iron loss.

Further, herein, with two non-magnetic layers 5 inserted in an intermediate portion (the eighth layer) of the region from the fifth layer to the twelfth layer formed with the inductor 3, the inductor 3 is configured as an inductor including a magnetic gap. With the inductor 3 provided with a magnetic gap, it is possible to improve the inductance value. Further, with the configuration in which both surfaces of each of those non-magnetic layers 5 are sandwiched by the coil conductors 7, direct current superimposition characteristics are improved.

Further, in the laminated inductor element 1, which is provided with the air gaps 12, it is preferable that the difference between the thermal expansion coefficient of the magnetic layer 4 and the thermal expansion coefficient of the non-magnetic layer 5 is greater than 0 ppm/° C. and less than 1 ppm/° C., for example. With a reduction in difference of the thermal expansion coefficients, it is possible to prevent, in the firing process, a crack occurring from the air gap 12 provided to increase the inductance value.

Any manufacturing method may be used to manufacture the laminated inductor element 1, as long as unfired ceramic green sheets are laminated and fired by the method. It is therefore possible to manufacture the laminated inductor element 1 in accordance with, for example, a non-shrinkage method.

According to the non-shrinkage method, an unfired multilayer ceramic body is formed in which ceramic green sheets capable of being fired at a low temperature and conductor patterns made of a low melting point metal are laminated, and upper and lower main surfaces of the multilayer ceramic body are both sandwiched by a constraining layer material having a thickness of about 50 μm to about 1000 μm, for example, and made of alumina or the like. The multilayer ceramic body is fired at a temperature of approximately 850° C. to 990° C., for example, and thereafter the constraining layer material is removed. According to this method, it is possible to prevent warping and distortion of the substrate.

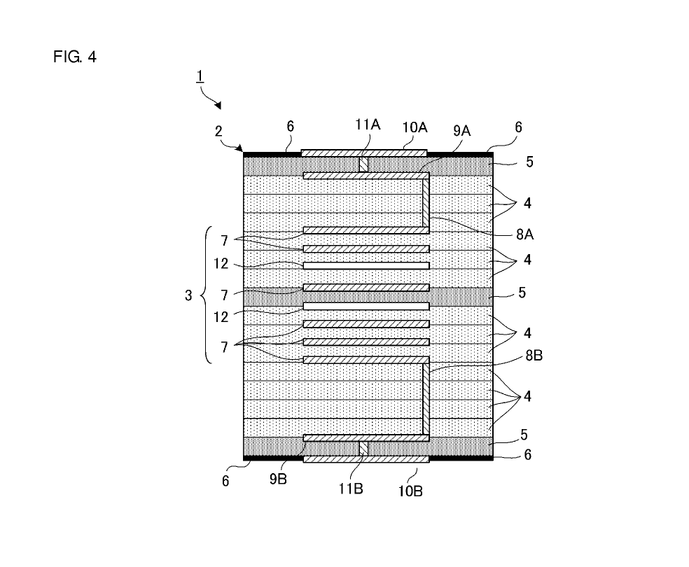

In FIG. 2, each of the cover layers 6 is provided on the entirety of a surface of the corresponding non-magnetic layer 5. The cover layer, however, may be provided on a portion of the surface other than the mounting land 9A or 9B. FIG. 4 is a schematic cross-sectional view of another example of the laminated inductor element 1. As illustrated in FIG. 4, each of the mounting lands 10A and 10B may be directly provided on a surface of the corresponding non-magnetic layer 5, and the cover layer 6 made of LTCC may be provided only around the mounting land 10A or 10B, i.e., only on a portion exposing the non-magnetic layer 5.

A specific configuration and so forth of the laminated inductor element 1 may be changed in design as appropriate. The functions and effects described in the above-described preferred embodiments are merely a list of the most preferable functions and effects provided by the present invention, and the functions and effects of the present invention are not limited to those described in the above-described preferred embodiments.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2. A laminated inductor element comprising:
a laminated substrate including a plurality of layers including a magnetic layer;
an inductor including coil conductors provided between layers of the laminated substrate and connected in a lamination direction of the laminated substrate; and
a pair of non-magnetic layers laminated on the laminated substrate so as to sandwich the laminated substrate in the lamination direction; wherein
the non-magnetic layers include low temperature co-fired ceramics.

3. The laminated inductor element described in claim 2, wherein each of the non-magnetic layers includes:
a conductor pattern located on a surface thereof; and
a via conductor configured to electrically connect the conductor pattern and the coil conductor.

4. The laminated inductor element described in claim 2, wherein the laminated substrate includes an air gap located about the coil conductor.

5. The laminated inductor element described in claim 4, wherein a difference between a thermal expansion coefficient of the magnetic layer and a thermal expansion coefficient of the non-magnetic layer is greater than 0 ppm/° C. and less than 1 ppm/° C.

6. The laminated inductor element described in claim 2, wherein the magnetic layers are made of magnetic ferrite and ceramic.

7. The laminated inductor element described in claim 2, wherein each of the magnetic layers has a thickness of approximately 100 μm to 2000 μm and a magnetic permeability of approximately 290.

8. The laminated inductor element described in claim 2, wherein the non-magnetic layers are made of a non-magnetic ferrite and ceramic.

9. The laminated inductor element described in claim 2, wherein each of the non-magnetic layers has a thickness of approximately 10 μm to 100 μm and a magnetic permeability of approximately 1.

10. The laminated inductor element described in claim 2, wherein the non-magnetic layers defining outermost layers include cover layers made of low temperature co-fired ceramics.

11. The laminated inductor element described in claim 10, wherein each of the non-magnetic layers defining outermost layers has a post-firing thickness of approximately 10 μm to 400 μm.

12. The laminated inductor element described in claim 10, further comprising mounting lands provided on the non-magnetic layers defining outermost layers.

13. The laminated inductor element described in claim 2, wherein the coil conductors are spirally conductors through via-hole conductors located in the laminated substrate.

14. A DC-DC converter comprising the laminated inductor element described in claim 2.
